(19) United States
(12) Patent Application Publication
(10) Pub. No.: US 2016/0157661 A1
(43) Pub. Date: Jun. 9, 2016

(54) Ground coffee filler assembly for espresso machine porta-filter

(71) Applicant: Edmundo Torquemada, Keller, TX (US)

(72) Inventor: Edmundo Torquemada, Keller, TX (US)

(21) Appl. No.: 14/561,983

(22) Filed: Dec. 5, 2014

(51) Int. Cl. A47J 31/06

(52) U.S. Cl. CPC A47J 31/0657

(57) ABSTRACT

A removable ground coffee filler assembly for espresso machine porta-filters, for attachment to commercially available porta-filters as an add-on item, having a filler with a conical and straight sections, and one adapter to attach the filler to the porta-filter. The adapter is secured to the filler by means of a press fit and to the porta-filter by means of multiple spring clip prongs.

### CROSS-REFERENCE TO RELATED APPLICATIONS

n/a

### STATEMENT REGARDING FEDERALLY SPONSORED RESEARCH OR DEVELOPMENT

n/a

### NAMES OF THE PARTIES TO A JOINT RESEARCH AGREEMENT

n/a

### REFERENCE TO A “SEQUENCE LISTING”. . .

n/a

### STATEMENT REGARDING PRIOR DISCLOSURES BY THE INVENTOR OR A JOINT INVENTOR

n/a

### BACKGROUND OF THE INVENTION

The present invention relates generally to ground coffee porta-filters used in commercial and consumer grade espresso machines, and specifically, to a removable ground coffee filler assembly that is attached to porta-filters by means of spring clip prongs.

Extraction of a beverage known as espresso is achieved by forcing hot water through finely-ground coffee that is tamped in the filter section of an assembly generally known as porta-filter. At typical porta-filter consists of a filter, a filter-holder, and a handle. The preparation of the espresso starts by filling an empty filter with ground coffee, tamping the coffee with a tool generally known as coffee tamper, attaching the porta-filter to the espresso machine, then allowing hot water to flow under pressure through the tamped coffee. As the volume of ground coffee before it is tamped is several times larger than after being tamped an individual preparing espresso will need to add more ground coffee to the porta-filter than its normal capacity. There are currently no practical and cost-effective methods of tamping the right amount of ground coffee in a porta-filter in one step and without some level of manual intervention or spillover. In many cases individuals preparing espresso will fill a porta-filter with ground coffee, tamp it, then add more ground coffee and tamp a second time to reach the right amount of tamped coffee. Tamping coffee twice can jeopardize the quality of coffee extraction with phenomena known as channeling, as one example. If done in one step, individuals attempting to avoid spillover may underfill the porta-filter with ground coffee and as a result, not be able to reach the desired amount of tamped coffee, or may overfill the porta-filter and waste some percentage of ground coffee due to spillover. Individuals preparing espresso may also do multiple manual rearrangements of ground coffee over the porta-filter during tamping, usually with a finger or a utensil.

There is a need for an easy-to-use, quick-to-install, and inexpensive add-on ground coffee filler assembly that allows individuals preparing espresso to add to a porta-filter the total amount of ground coffee needed without spillover, achieve an even distribution of ground coffee prior to tamping, tamp the ground coffee in one single action, avoid areas of different density in the tamped coffee, avoid human contact with the ground coffee, and avoid manual rearrangement of the ground coffee during the tamping process.

### SUMMARY OF THE INVENTION

It is an object of the present invention to provide a ground coffee filler assembly that is removable and enables individuals preparing espresso to evenly fill espresso machine porta-filters with the total desired amount of ground coffee and without spillover. It is also an object of the present invention to provide a filler assembly that allows tamping the ground coffee in one single action. It is also an object of the present invention to provide a filler assembly that can be used in any commercially available porta-filter. It is further an object of this invention to provide a filler assembly that is easy to use, quick to attach and detach from a porta-filter, and inexpensive. It is still further object of the present invention to allow tamping without human contact with the ground coffee. Another object of the present invention is to avoid manual rearrangement of the ground coffee before or during the tamping process.

The present invention fulfills these objectives and provides a unique and beneficial filler assembly which is inexpensive, easy to install, and can be used on commercially available espresso machine porta-filters. In accordance with the present invention the assembly utilizes one adapter to hold the filler firmly but temporarily to a porta-filter by means of three spring clip prongs. The body of the filler is sized to fit commercial sizes of porta-filters, hold the right amount of coffee needed for the desired volume of espresso, and allow the use of a coffee tamper while attached to the porta-filter.

### BRIEF DESCRIPTION OF THE DRAWINGS

FIG. 1 is a side view of the present invention;

FIG. 2 is a side view of the filler without the adapter.

FIG. 3 is a side view of the adapter without the filler;

FIG. 4 is an elevated view of the adapter without the filler;

FIG. 5 is a cross-sectional view of a typical porta-filter;

FIG. 6 is a side view of the present invention installed in a typical porta-filter;

FIG. 7 is a side view of a typical coffee tamper;

FIG. 8 is a cross-sectional view of the present invention in use with a typical porta-filter and a typical coffee tamper.

### DETAILED DESCRIPTION OF THE INVENTION

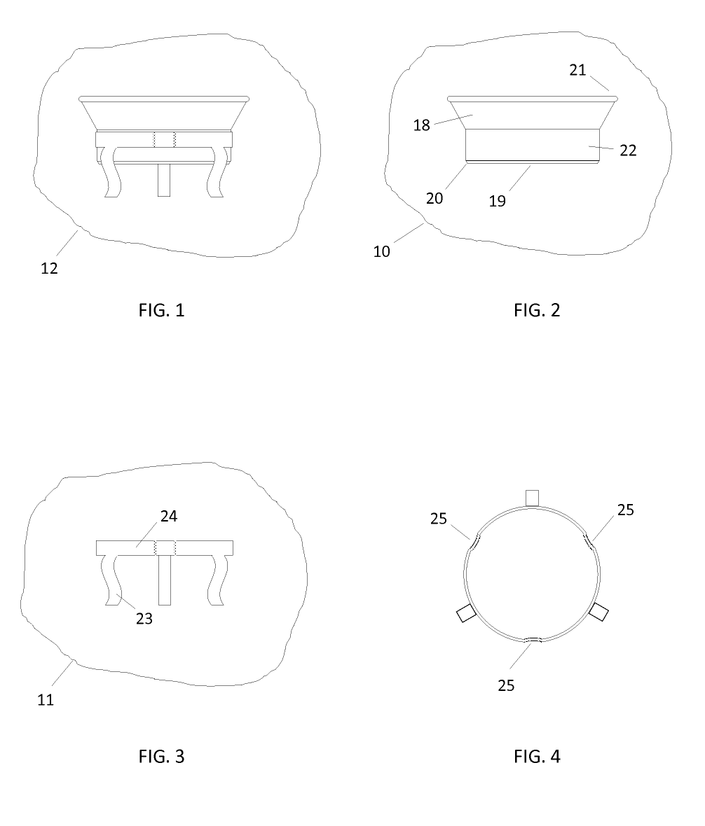

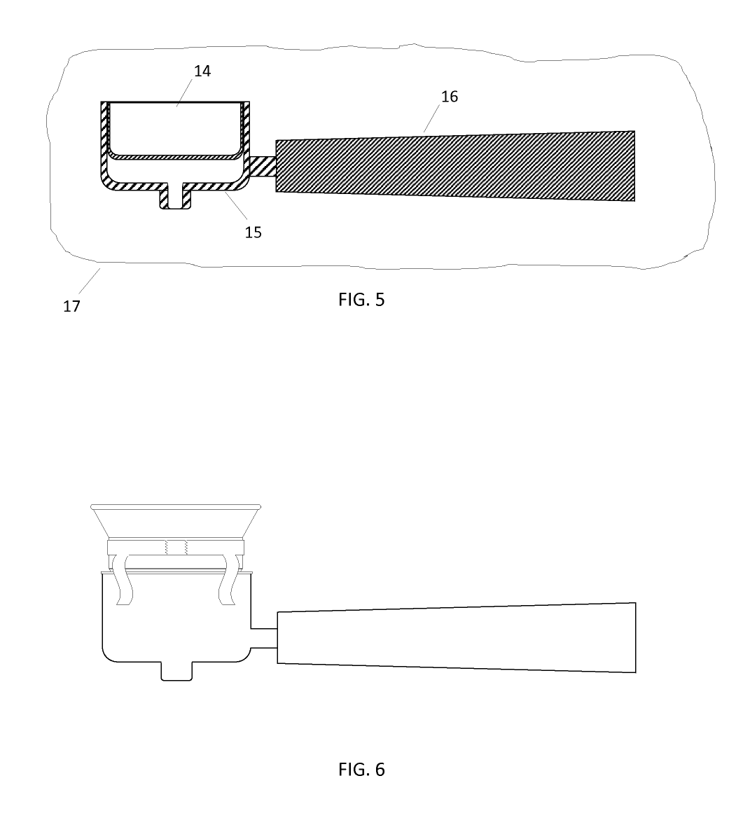

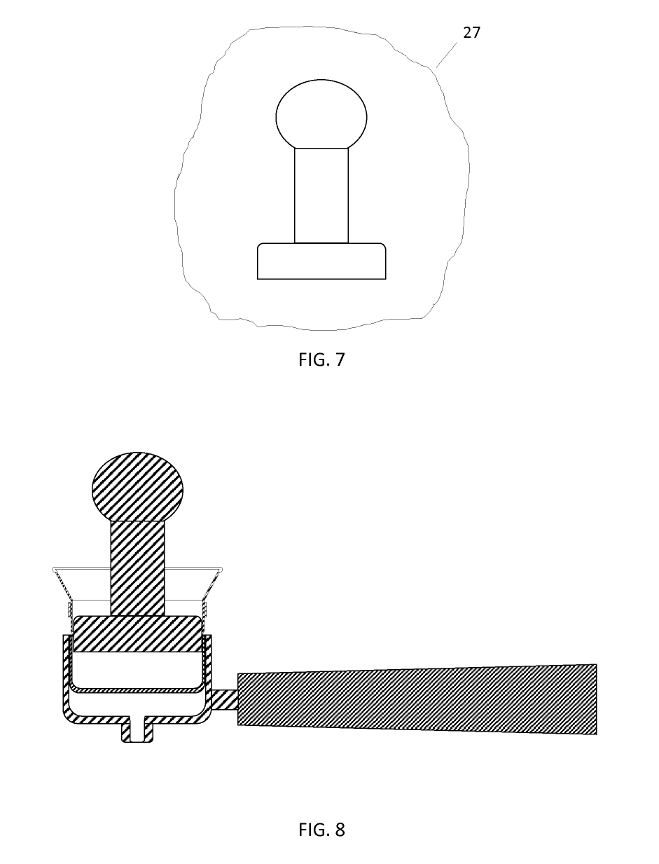

The coffee filler assembly in accordance with the present invention is illustrated in FIG. 1 and generally referred to by the reference numeral 12. The assembly 12 is particularly adapted to be used as an add-on item to an espresso machine porta-filter illustrated in FIG. 5 and generally referred to by the reference numeral 17.

As illustrated in FIG. 5, a typical porta-filter 17 includes a handle 16, a filter-holder 15, and a filter 14. Both the filter-holder 15, and the filter 14 are generally constructed of nickel-plated or chrome-plated carbon steel or stainless steel. The handle 16 is typically constructed of plastic or resin. Internal diameter of the filter 14 typically ranges from 46 mm to 58 mm.

The filler assembly 12 consists of filler 10 illustrated in FIG. 2, and adapter 11 illustrated in FIG. 3. The filler will generally be made of stainless steel and have smooth edges to prevent injuries. The internal diameter of the lower end 19 of the filler 10 will be approximately the same internal diameter of the corresponding filter 14 to prevent the filler 10 from sliding into the filter 14; this internal diameter of lower end 19 of filler 10 will also be preferably of different sizes to fit commercially available sizes of filter 14. The lower end 19 of the filler 10 will have a beveled edge 20 to align the interior walls of filler 10 with the interior walls of filter 14. The upper edge 21 of the filler 10 will be curled to avoid sharp edges. The middle section 22 of the filler 10 will be straight, and the upper end 18 of the filler 10 will be conical to facilitate funneling of the ground coffee to the straight section 22 and guide the path of tamper 27 through the filler 10. The adapter 11 will generally be made of stainless steel with smooth edges to prevent injuries, and will be preferably heat-treated to provide spring tension on the prongs 23 and in the band 24 that affixes it to the filler 10. When together, the filler assembly 12 will feel as a single unit, but will be detachable for cleaning purposes.

In accordance to this invention the adapter 11 has two purposes: one is to temporarily affix the filler 10 to the porta-filter assembly 17; the second is to align the exterior walls of filler 10 with the exterior walls of filter-holder 15. The tension in the prongs 23 of the adapter 11 will be such that a gentle force will be required to affix the assembly 12 to the porta-filter 17. The lengths of the prongs 23 of adapter 11 will be long enough that they establish contact with the outside wall of the filter-holder 15 but short enough that will avoid interferences with other elements of the porta-filter assembly including the handle 16, as an example. The rim 24 of the adapter 11 will have three or more formed areas 25 to generate a slight to medium press fit that will hold adapter 11 together with filler 10.

Although the present invention is described above with reference to having three support prongs 23 and one support rim 24, it is understood that the present inventive filler assembly is not limited to that precise number of prongs and attachment rim. For example, the adapter can utilize more prongs if needed to fit a particular design of porta-filter. Also, the support rim 24 may be altered to also fit a particular design of porta-filter.

It is also understood that the filler assembly illustrated in FIG. 1 is not limited to the constructional detail shown there or described in the accompanying text. As those of skill in the art will understand, a suitable filler assembly can be fabricated from aluminum, nickel-plated carbon steel, chrome-plated carbon steel, plastics, or other materials.

Those in the art will understand that a number of variations may be made in the disclosed embodiments, all without departing from the scope of the invention, which is defined solely by the appended claims.

1. A ground coffee filler assembly that temporarily attaches as an add-on item to commercially available porta-filters used in espresso machines, whether they are commercial or consumer grade. The porta-filter consisting of a filter-holder, a filter, and a handle. The ground coffee filler assembly consisting of:
a. A filler that has a beveled lower end edge, a straight middle section, and a conical upper section with curled edge.
b. An adapter that has a support rim which is formed in three or more areas and has multiple spring clip prongs.

2. A ground coffee filler assembly as described in claim 1 wherein said adapter is attached to the filler by means of a press fit.

3. A ground coffee filler assembly as described in claim 1 wherein said adapter attaches to commercially available porta-filters by means of multiple spring clip prongs.

4. A ground coffee filler assembly as described in claim 1 wherein said filler aligns its exterior walls with the exterior walls of a filter-holder by means of and adapter with multiple spring clip prongs.

5. A ground coffee filler assembly as described in claim 1 wherein said filler aligns its interior walls with the interior walls of a filter by means of a beveled edge in the lower end of the filler.
